(19) United States
(12) Patent Application Publication
(10) Pub. No.: US 2011/0246677 A1
(43) Pub. Date: Oct. 6, 2011

(54) SYSTEMS AND METHODS FOR CONTROLLING COMMANDS FOR TARGET DEVICES

(75) Inventors: Stephen Johnson, Colorado Springs, CO (US); Timothy Hoglund, Colorado Springs, CO (US); Larry Rawe, Colorado Springs, CO (US); Nick Pelis, Colorado Springs, CO (US); Brad Besmer, Colorado Springs, CO (US)

(73) Assignee: LSI Logic Corporation

(21) Appl. No.: 12/753,977

(22) Filed: Apr. 5, 2010

(51) Int. Cl. G06F 3/00

(52) U.S. Cl. 710/10; 710/19

(57) ABSTRACT

Methods and systems use a hardware controller for controlling commands sent to a plurality of target devices. The controller controls queuing of commands according to respective target device allowed queue depths set in hardware circuitry of the controller. Status of each one of the plurality of target devices is monitored also using controller hardware circuitry. The allowed queue depths can be set in the hardware controller circuitry using firmware and can by dynamically adjustable based on the status of the target devices. Hardware circuitry of the controller is also used to control queuing of commands, for each one of the plurality of target devices, according to the queue depth setting for the target device.

### TECHNICAL FIELD

Embodiments relate to fields of computers systems and, more particular but not exclusively, to methods and systems for handling commands sent to target devices of a computer system. Embodiments also relate to command queuing. Embodiments additional relate to SAS/SATA controllers.

### BACKGROUND

Initiator devices connect computer operating systems or other host systems to network and storage devices. Initiators are the end points that initiate sessions and send commands whereas the targets are the end points that wait for the initiator's commands and provide required input/output (IOs) data transfers. Initiators are coupled to targets via a subsystem or links.

Serial attached SCSI (SAS) and Serial Advanced Technology Attachment (SATA) are some examples of data transfer technologies for moving data to and from target devices including computer storage devices such as hard drives, optical discs, and tape drives. SAS is a serial, point-to-point, enterprise-level device interface that leverages the proven SCSI protocol set. SAS is a convergence of the advantages of SATA II, SCSI, and Fibre Channel, and is the future mainstay of the enterprise and high-end workstation storage markets. SAS offers a higher bandwidth per pin than parallel SCSI and it improves signal and data integrity. The SAS interface uses the proven SCSI command set to ensure reliable data transfers while providing the connectivity and flexibility of point-to-point serial data transfers. The serial transmission of SCSI commands eliminates clock-skew challenges. The SAS interface provides improved performance, simplified cabling, smaller connectors, lower pin count, and lower power requirements when compared to parallel SCSI. SAS controllers leverage a common electrical and physical connection interface that is compatible with Serial ATA technology.

Improved methods and systems are needed for controlling commands to target devices. It is believed that the methods and systems of the illustrative embodiments meet such a need.

### BRIEF SUMMARY

The following summary of the invention is provided to facilitate an understanding of some of the technical features related to technique and apparatus for controlling commands for a plurality of target devices and is not intended to be a full description. A full appreciation of the various aspects of the invention can be gained by taking the entire specification, claims, drawings, and abstract as a whole.

The aforementioned aspects of the invention and other objectives and advantages can now be achieved as described herein.

According to one aspect, a method is provided for controlling commands for a plurality of target devices. The method can comprise: setting in circuitry of a hardware controller allowed to queue depths of each one of a plurality of target devices supported by the controller; monitoring status of each one of the plurality of target devices using circuitry of the hardware controller; and, for each one of the plurality of target devices, using circuitry of the hardware controller to control queuing of the commands according to the queue depth setting for the target device.

According to another aspect, a hardware controller is provided for controlling commands for a plurality of target devices. The hardware controller can have queue depth settable circuitry, target monitoring circuitry, and queue management circuitry. The queue depth settable circuitry can be adapted to enable allowed queue depths of each one of a plurality of target devices supported by the controller to be set in the circuitry. The status monitoring circuitry can be adapted to monitor status of each one of the plurality of target devices. The queue management circuitry can be adapted to control queuing of the commands for each one of the plurality of target devices according to the queue depth setting for the target device.

According to yet another aspect, a system is provided for controlling commands for a plurality of target devices. The system can have an initiator and the aforementioned hardware controller is operably coupled to the initiator.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a computer system architecture including a command queuing hardware controller, according to one embodiment;

FIG. 2 is a block diagram of an embodiment of the hardware controller of FIG. 1;

FIG. 3 illustrates a flow chart outlining a method for controlling commands to a plurality of target devices, according to an embodiment;

FIGS. 4A and 4B illustrate a flow chart describing in detail a method for controlling queuing in response to task management and/or exception cases, according to one embodiment;

FIG. 5 illustrates a flow chart outlining a method for controlling priority and/or quality of service of commands to a plurality of target devices, according to one embodiment;

FIG. 6 illustrates a detailed schematic diagram of a SAS hardware controller including an FPE engine, according to an embodiment; and

FIG. 7 illustrates a high level IO flow for the SAS controller of FIG. 6.

### DETAILED DESCRIPTION

The particular values and configurations discussed in these non-limiting examples can be varied and are cited merely to illustrate at least one embodiment of the present invention and are not intended to limit the scope of the invention.

SAS/SATA controllers and other initiator controllers process commands sent by a host operating system which typically is allowed to send many more commands to the controller then the controller can send to a target device. This requires the controller to keep track of the number of commands outstanding to each device (numbers of commands the controller has active to the target device) and if the host sends more commands than allowed by the device or more commands that may hinder overall performance (queue full status), the controller should queue the commands based on a queue depth per target devices that is managed by the controller.

Heretheto now, this type of queue depth management is typically performed by firmware based algorithms running on embedded CPU/s within the controller. In order to increase performance (reduce the firmware command processing time), the controller must support faster and/or multiple CPU's to run the firmware algorithms. This typically increases one or all (cost, power, size, complexity, time to market). Some solutions (controllers) require that the operating system manage the queues so the controller does not have to. These solutions typically require more complex drivers that have to execute more code per command than solution that have the controller do it.

Technical features described in this application can be used to construct various systems and methods for controlling commands for a plurality of target devices. The approach implements functionality in a hardware controller to handle command queuing concurrently on a per “device handle” basis. The hardware controller handles command queue depth control to reduce target queue full exceptions status and to limit command queue depths for devices with limited queue depths such as, for example, SATA NCQ 32, that does not require any firmware processing. This approach can also allow for firmware to determine when to start and stop queuing commands during expectation cases. Also, the approach can enable queued commands to be automatically started after the completion of previous commands and can allow for firmware to start queued commands. A single physical target can have multiple associated device handles where each device handle has separate command queues, queue depths, and initiator address. The hardware can keep state information on a per device basis and adjusts it per command during the start and completion processing.

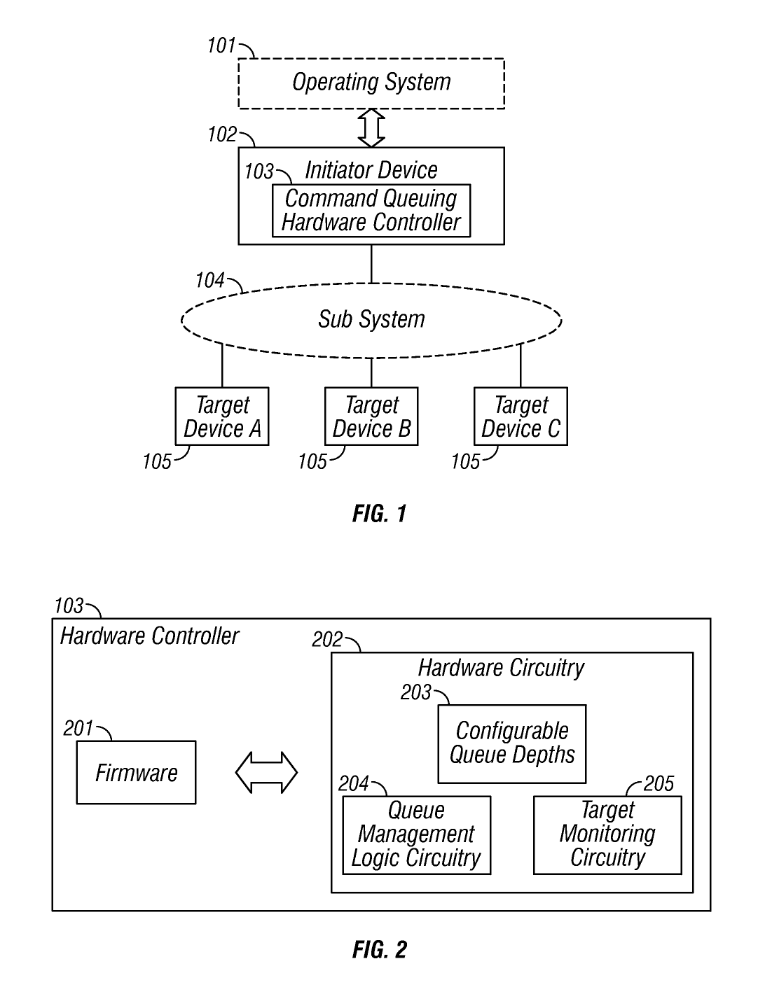

An example of a computer system architecture including a command queuing hardware controller, according to one embodiment, is illustrated in FIG. 1 of the accompanying drawings. The system has an initiator device 102 for processing commands sent by a host operating system 101 and for sending the commands to one or more target devices 105. The initiator device 102 is operably connected to a plurality of target devices 105 via a sub system 104. The initiator device 102 includes a command queuing hardware controller 103 for handling command queuing concurrently on a per target device basis.

The initiator device 102 may be, for example, a serial attached SCSI (SAS) initiator, Serial Advanced Technology Attachment (SATA) imitator, or Serial Tunneling Protocol (STP) initiator. The sub system 104 can comprise direct connections (physical links), expanders, or a combination thereof to link the initiator device 102 to the plurality of target devices 105. The subsystem configuration can vary depending on the number and type of target devices. For example, a SAS initiator may be coupled to a plurality of target devises using one or more SAS expanders. The target devices 105 may be, but not limited to, hard disk drives, optical drives, tape drives, and other types of storage devices.

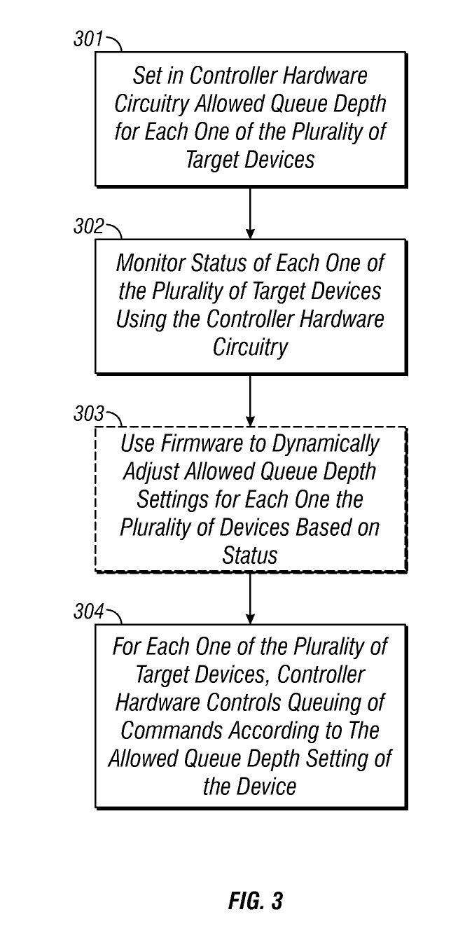

The command queuing hardware controller 103 may be physically included in the initiator device 102 itself or external to the initiator device 102. The controller 103 can be an ASIC or other hardware circuitry. Referring additionally to FIG. 2, which is a block diagram of the command queuing hardware controller according to one embodiment, as will be explained in more detail below, hardware controller 103 is configured to handle command queuing for each one of the plurality target devices 105 independently. Command queuing is the process of storing commands to be executed. Stored commands are not necessarily executed in the same sequence as they are received. The order of command execution is optimized to increase performance of the target device.

Hardware controller 103 includes queue management logic circuitry 204, configurable queue depths 203, and target monitoring circuitry 205. For each one of the plurality of target devices 105, target monitoring logic circuitry 205 is configured to monitor the status of the target device 105 to keep track of the number of commands outstanding to the target device. Target monitoring circuitry 205 can be configured to monitor state information on a per device basis and per command. Also, for each one of the plurality of target devices 105, queue management logic circuitry 204 controls the number of commands outstanding to the target device by queuing the commands according to an allowed queue depth 203 assigned to the target device. The queue depth is the number of commands a device can hold in its command queue. When the queue is full, the target device will refuse to accept any additional commands. The device will continue to refuse new commands until at least one command has been completed, freeing up space in the queue. The allowed queue depth 203 for each particular device resides in hardware circuitry 202 of the controller as settable flag bits. The queue depth flag bits can be settable by firmware 201. The allowed queue depth value can be settable anywhere between a minimum or maximum value supported by the particular target device.

The queue management logic circuitry 204 can be further configured to automatically start queued commands after completion of previous commands. The firmware 201 can be further configured to determine when to start and stop queuing commands during exception cases and can be configured to start queued commands also.

In one embodiment, the hardware circuitry 202 in controller 103 is adapted to enable the allowed queue depths 203 to be adjustable by the firmware 201. For example, for each target device 105, the allowed queue depth 203 can be dynamically increased or decreased by the firmware 201 adjusting the allowed queue depth bit flags based on status reported back to the initiator by the target. The allowed queue depth 203 can be adjusted per command during the start and completion processing. This improves the per command processing performance of the initiator device.

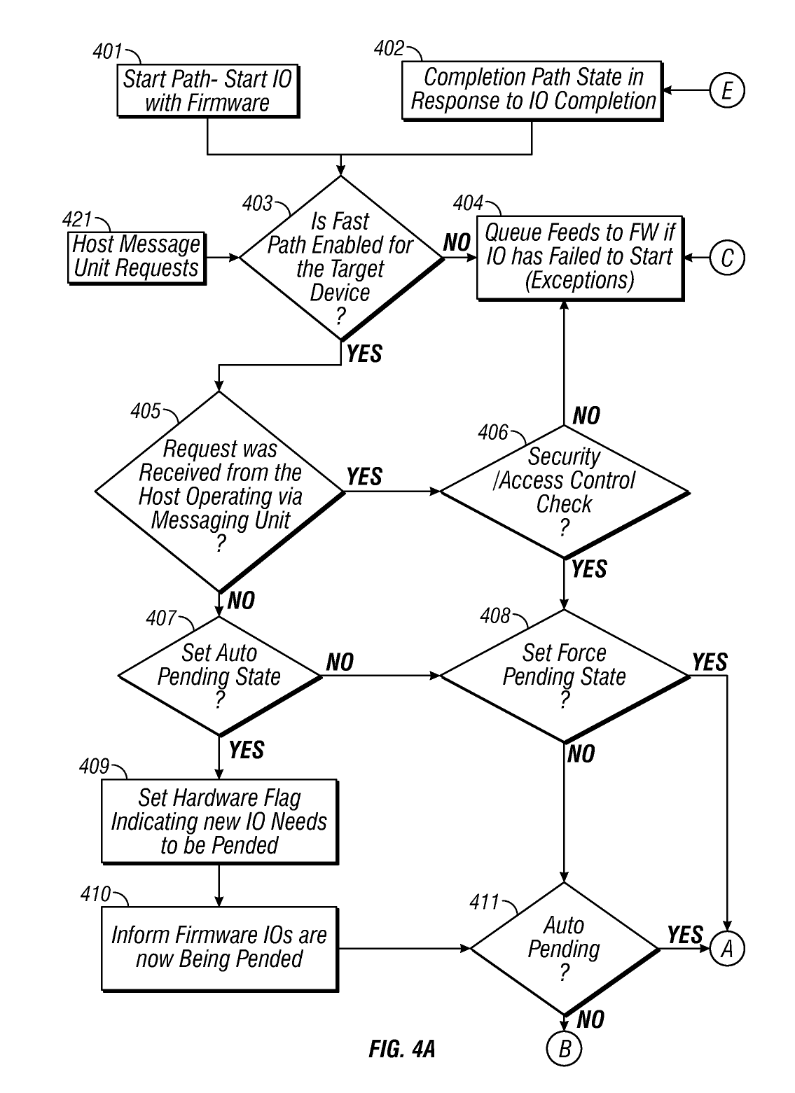

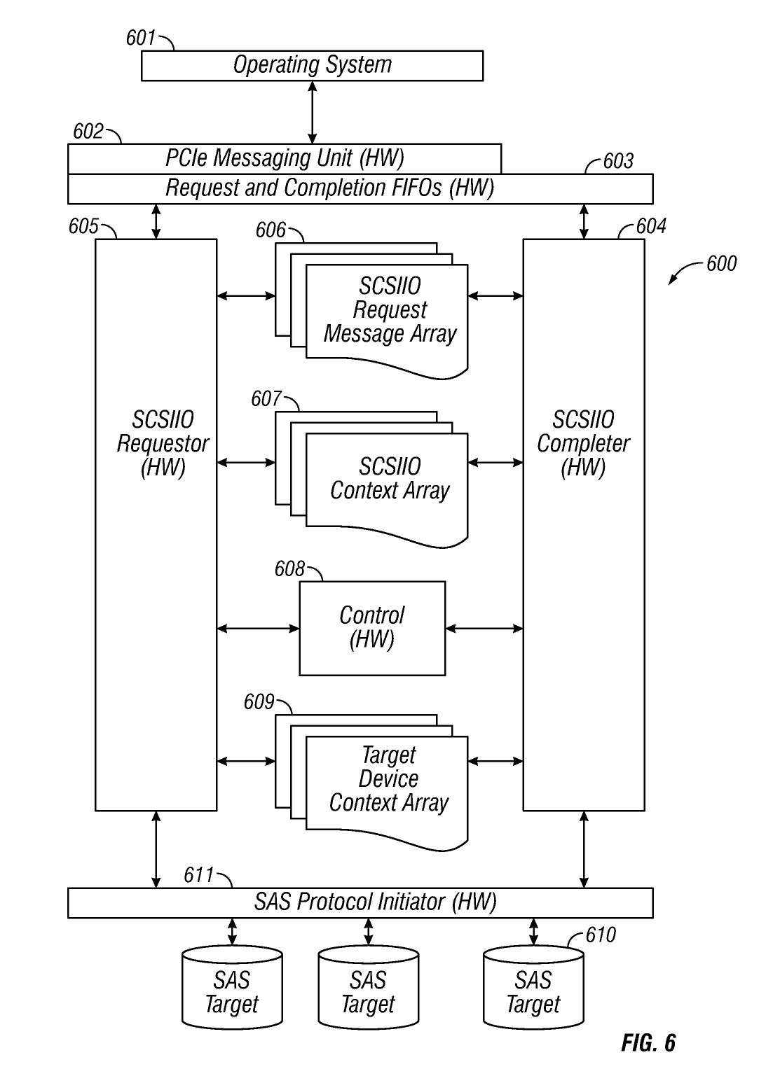

FIG. 3 illustrates a flow chart of a method for controlling commands of a plurality of target devices according to one embodiment. The method of FIG. 3 can be implemented in the computer system architecture including command queuing hardware controller 103 (see FIGS. 1 and 2). Initially, an allowed queue depth 203 for each one of the plurality of target devices 105 is set in hardware circuitry of controller 103 using firmware 201 (301). Status of each one of a plurality of target devices 105 supported by initiator 102 is monitored using hardware controller 103 (302). If necessary, for each one of the plurality of devices, firmware 201 can dynamically adjust the allowed queue depth setting 203 in response to monitoring the status of the target device (303). For each one of the plurality of target devices 105, queuing of commands is controlled according to the target device allowed queue depth 203 set in hardware controller 103 (304). Method of FIG. 3 can also be implemented in the embodiment of the system of FIG. 6, as will be explained in more detail below.

Method of FIG. 3 can serve to queue and throttle control or pend commands (input/outputs (IO's)) for particular devices for status. For example, this would be the case in which first target device A 105 supports a queue depth which is limited with respect to the queue depth supported by second target device B 105 (FIG. 1). By way of example, consider that first target device A 105 is a hard drive that has a limited queue depth and can only support 32 concurrent IOs at any given time. Consider further that second target device B 105 is a SAS drive that can support queue depths of say 1000. The queue depths that the operating system 101 can send are significantly higher than 32. According to the command queuing method of the embodiments, the allowed queue depths 203 set in the hardware controller 103 using firmware 201 would be a maximum of 32 for first target A 105 and a maximum of 1000 for second target B. Hardware controller 103 can queue commands to first target A 105 according to a set queue depth 203 of 32 and to second target B 105 according to a set queue depth of 1000. Consequently, in the aforementioned example, implementing the command queuing method of the embodiments effectively throttles IOs to first target A 105 to ensure that only 32 outstanding IOs are valid.

As will be explained in more detail below, in one embodiment, a state machine of the hardware controller can be additionally configured to control pending for task management or other exception cases.

Reference will now be made to FIG. 6 which illustrates, in detail, a computer system architecture including a command queuing SAS hardware controller, according to one embodiment. SAS hardware controller includes a Fast Path Engine (FPE) hardware controller 600 configured to provide an automated fast path. The FPE is configured to provide a completely hardware automated IO path that does not require any firmware assistance to start or complete a SCSI Command Request Message.

The SAS Controller “Fast path Engine” 600 comprises two major hardware blocks, the requestor 605 and completer 604. These hardware blocks work concurrently on processing IO requests from the operating system and forwarding those requests to a SAS initiator protocol engine 611. The completer 604 processes completed successful commands from the SAS protocol engine 611 and completes those commands back to the operating system by way of the messaging unit hardware 602 (PCIe register set interface).

Requestor 605 and completer 604 manage queuing of new command requests from the operating system on a per target device basis. Queuing is controlled by Qdepth programmed within a SAS target device context array 609 (FPE device structure) by the controller firmware. The FPE device structure stores context and control information about the specific target end device. This IO count can be adjusted (Read/Write) at anytime by the controller firmware (FW) through atomic hardware register access located in a FPE register control block 608.

The Fastpath Engine 600 manages the queue depths of each target Device 610, managing a separate linked list of IO requests (commands) on a per target device basis. Target Devices can be, for example, SAS Expanders, SAS end devices, and/or SATA target devices. (See T10 SAS specification).

FPE handles pending IOs for QFull and firmware controlled exception cases. The FPE includes a state machine including command structure. In the specific embodiment of FIG. 6, FPE has IO context structure within context array structure 607 in which the machine states are represented as bits. IO context structure stores request message context information in case the firmware needs to take over the IO and cleanup any error or exception conditions. It also stores information needed to build a reply structure when replying back to the operating system 601. FPE also includes a request message array 606.

Each SCSI, SATA device, or other target device (per DevHandle) is classified as fast path capable. Each IO request is classified as fast path capable. A DeviceHandle is an index into the target device context array 609. The firmware determines which devices and/or DevHandles are fast path enabled; this may be determined by the device type when the firmware creates the DevHandle at device discovery time. The host driver determines which IO is Fastpath by selecting a SCSI command request message descriptor type.

The OS driver can choose to send an IO as fast path or normal by building different request descriptors. Note that not all SCSI command request messages will be Fastpath capable, for instance, SATA non R/W commands. Note also that not all device types are Fastpath capable such as IR volumes and some SATA, SES, and ATAPI devices.

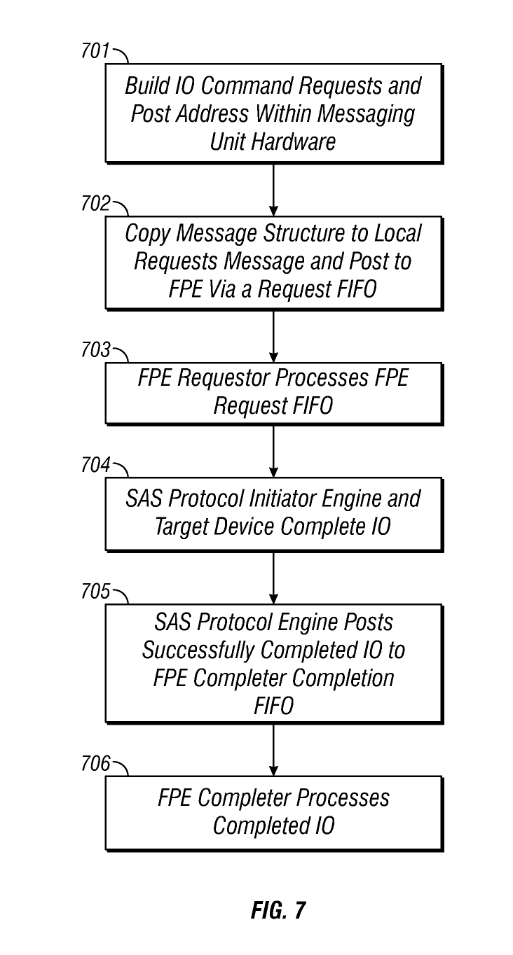

FIG. 7 outlines IO flow of the SAS controller of FIG. 6, according to one embodiment. The operating system 601 builds a new command request and posts the address of the IO request structure via register within the PCIe messaging unit hardware 602 (process 701). The messaging unit hardware 602 DMA copies the message structure to a local (within the controller) requests message and posts the local address to the Fast path Engine 600 via a requests first in first out (FIFO) (process 702).

FPE requestor 605 processes (is the consumer of) the FPE Request FIFO (process 703). To this end, requestor 605 validates the request is correct and the device is enabled. Requestor 605 can validate the request by validating the SCSI command request message parameter.

The FPE requestor 605 checks per device firmware settings that control operations of the device. The FPE requestor 605 does this by checking FPEDevice FWFlags of the device structure within target device context array 609. The requestor 605 stores (manages) context information about the requests in the FPE Device context data structure. This context information comprises Active loCount, Pending IO Linked list, and HW State Flags. The requestor 605 passes control of IO structure to SAS initiator protocol engine 611 if all tests pass and IO is OK to send to target device 610.

The SAS protocol engine 611 and target device 610 complete IO (process 704). The SAS protocol engine 611 posts successfully completed IO to the FPE Completer completion FIFO 603 (process 705).

The FPE completer 604 processes the completed IO (process 706). To this end, the FPE completer 604 updates the active IOCount and context information of the FPEDevice context structure and the IO context structure. The FPE completer 604 collects information and builds the reply structure and posts this to the Messaging unit hardware to reply back to the operating system via the MU Reply FIFOs.

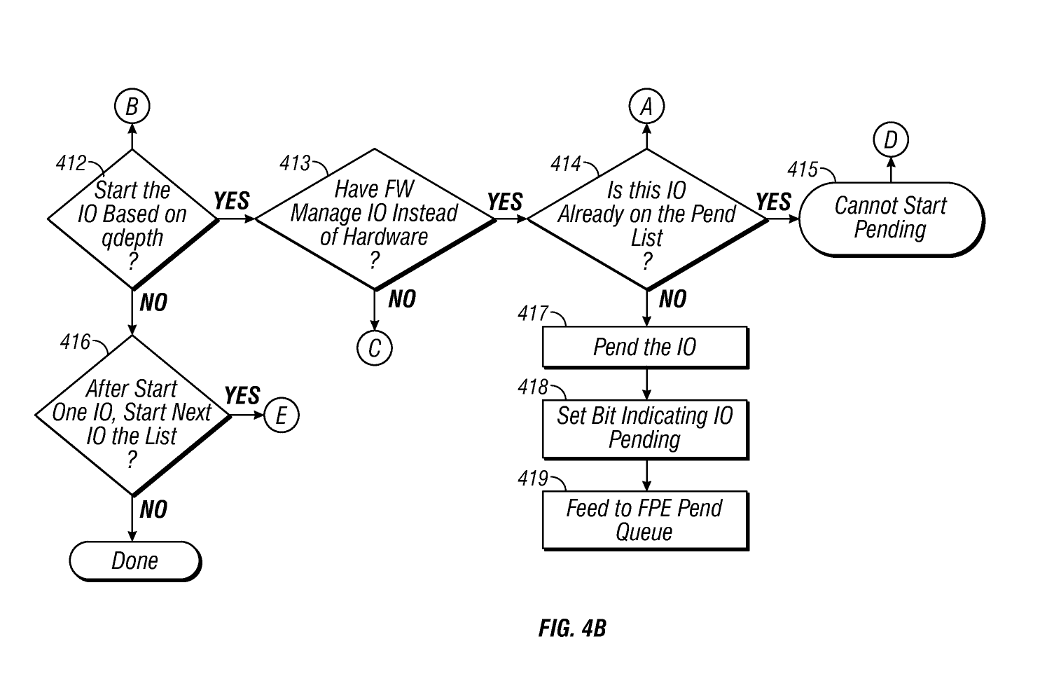

A command queuing method according, to an embodiment, will now be described in detail with, reference to the system of FIG. 6 and additionally FIGS. 4A & 4B which are flow charts showing in detail how IOs (commands) can be pended (queued) based on a queue depth or some firmware settable flags in the command structure or on a per device basis that queues all commands. In this particular example, the hardware handles pending IOs for firmware controlled task management or other exception cases.

Host message unit requests (includes set of virtual function requests queue) is provided (421). A start path and completion path operate concurrently. The start path is initiated by the firmware posting to request queue to start IO (401). The completion path feeds a completion state in response to completion of an IO (402). A list of pending IOs waiting to start is linked to the completion path. When the FPE hardware completes processing of an IO (command) on the completion path, the FPE checks the list to see if any commands are currently pending and starts those next before any new ones are received from the host.

A determination is made as to whether fast path through the FPE hardware is enabled for the target device (403). The Fast Path (FP)_Enable hardware flag is used to indicate if fast path is enabled for the target device associated with the IO. The FP_Enable flag is set in response to the firmware determining if the target device can be processed by the hardware fast path. If fast path is not enabled for the associated target device, the IO fails to start (exception) and the queue feeds to the firmware (404). If the fast path is enabled, a determination is made as to whether an IO request was received from the host operating via the messaging unit (405). If so, a security/access control check is undertaken to determine if the request came from a host queue that the target device is allowed to receive commands from (406) (hardware supports sr-iov, multiple request host queues from different PCIe virtual functions). If not, IO fails to start and queue feeds to firmware (404).

If a request was not received from the host operating via the messaging unit (405), the firmware sets an auto pending flag in the state machine for a given IO (FW start IO, host cannot set this bit) when it wants the hardware to start pending this IO and all following IOs until the firmware clears the bit. If auto pending is not started or is stopped (407) or the security/access control check determines a request came from a host queue that the target device is allowed to receive commands from (406), the firmware also has the option to force pending (set force pending hardware flag) when the firmware requires the hardware to force start pending IO for a given device (408). A common case for SATA device is when a non-NCQ command comes in. All current NCQ commands for the device must be completed before the non-NCQ command is started. While waiting for the NCQ command to complete, all new requests must be pended. The firmware will also set this when it is dealing with SCSI Task Management cases (aborting commands or resetting the target).

If it is determined that pending mode for a given target is set (407), a hardware flag is set when the first IO is pended and cleared when the last IO on the pend list gets started (409). The flag indicates that a new IO needs to be pended at the end of the list. A synchronous event back to the firmware informs the firmware that IOs are now being pended (410). The auto pending mode is set (411) in response. Auto pending is also set if force pending mode is not set (408).

The firmware clears both the pending bits (Auto pending and/or force pending) for non-native command queue (NCQ) command and Task management cases. If the auto pending mode (411) is not set, the process makes a determination as to whether the IO can start based on queue depth (412). If so, instead of having the hardware manage the pending IO, it can be sent to the firmware to have the firmware manage the IO (413). If the IO is either sent to firmware to manage IO (414), force pending mode is set (408), or the auto pending mode (411) is set, a determination is made as to whether the IO is already on the pending list (414). If the IO is already on the pending list, the pending IO cannot start so the IO remains at the head of the pending list (415). If the IO is not already on the pending list (414), a pending process is implemented in which the IO is pended (417). A hardware bit is set to indicate that the IO is being pended (418). The IO is fed to the FPE engine pend queue (419).

If IO is not sent to firmware to have firmware manage the IO (413), the IO fails to start (exception) (404). If the IO cannot be started based on qdepth (412), after starting one IO, the next pend IO on this list is started (416). This keeps the state machine in this “start pending” state until it either starts all pending IOs or reaches qdepth limit. If the state machine can start all pending IOs (416), the process turns to start path (401). Otherwise, process is done.

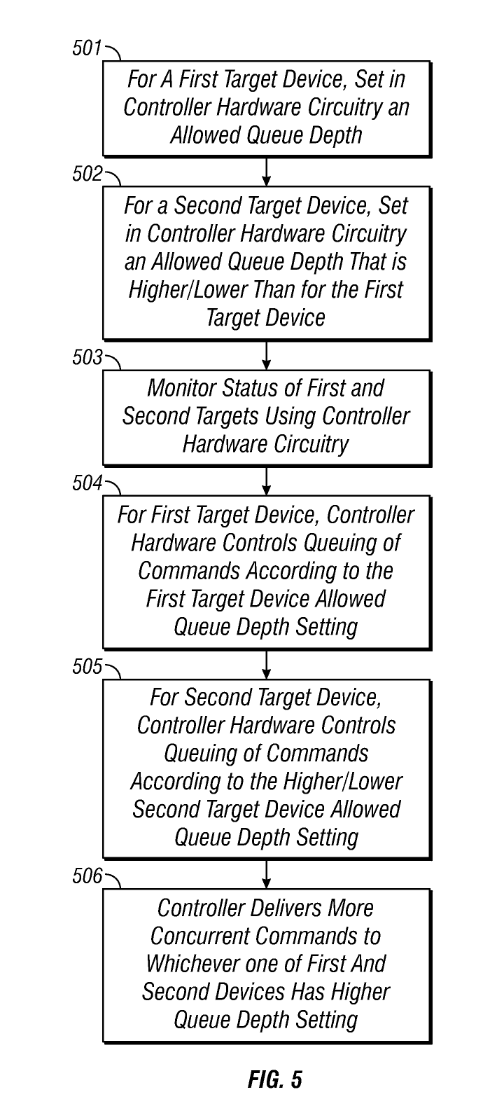

In yet another embodiment, controlling of the queue depths for respective target devices according to the aforementioned methods and systems of the embodiments can be utilized to provide different priority and quality of service for different IOs flows to target devices. Reference will now be made to FIG. 5, which outlines such a method implemented in the system of FIGS. 1 and 2. By way of example, consider the case in which an allowed queue depth 203 for a first target device A is set in the controller hardware to a higher or lower value than the allowed queue depth for the second target device B (501 and 502). Note that the allowed queue depth values need only be supported by the target devices and can be set between the maximum and minimum queue depths of the target devices. The status of the first and second targets is monitored using controller hardware (503). For the first target device A, queuing of commands is controlled according to the first target device allowed queue depth 203 set in the controller hardware (504). For the second target device B, queuing of commands is controlled according to the higher or lower allowed queue depth 203 of the second target device B (505).

If the queue depth setting 203 for the first target device A is higher than the second target device B, the hardware controller 103 will deliver more concurrent commands to first target device A than to the second target device B. Similarly, if the queue depth setting 203 for the first target device A is lower than the second target device B, the hardware controller 103 will deliver more concurrent commands to the second target device B than to the first target device A. Thus, the hardware controller delivers more concurrent commands and therefore priority to whichever one of the first and second target devices has the higher queue depth setting (506). This means that priority and quality of service for IOs to different target devices can be controlled by adjusting the allowed queue depths settings 203 for the different target devices (within the maximum and minimum values supported by the target devices). Controlling the queue depths of the plurality of targets to make one or more particular target devices have more concurrent IOs then the others results in the particular target device(s) having slightly higher priority than the others and the controller delivering more bandwidth to the operating system for that particular target or set of targets. The method of FIG. 5 can also be implemented in the system of FIG. 6

The system and methods of the illustrative embodiments handle multiple devices concurrently and track the number of outstanding commands to each device and the queue depth control of each device independently. This can eliminate firmware processing of commands by the controller when the command queue depth handling is required based on per device queue depths which reduces the overall per command processing time by the controller. The systems and methods of the embodiments greatly improve the overall per IO performance of the controller without having to increase the CPU clock frequency or to add multiple CPU cores. This solution reduces command processing overhead compared to a solution that requires a driver to handle the command queuing. Eliminating CPU assistance from the normal IO path can reduce CPU performance requirements, reduce, and align arbitrated memory accesses to improve performance of memory subsystems, and possibly allow use of smaller and more energy efficient designs.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only.

Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics.

The embodiments of the invention, in which an exclusive property or right is claimed, are defined as follows. Having thus described the invention what is claimed is:

1. A method for controlling commands for a plurality of target devices, the method comprising:
setting in circuitry of a hardware controller allowed queue depths of each one of a plurality of target devices supported by the controller;
monitoring the status of each one of said plurality of target devices using circuitry of said hardware controller; and
for each one of said plurality of target devices, using circuitry of said hardware controller to control queuing of said commands according to the queue depth setting for the target device.

2. The method of claim 1, further comprising:
using circuitry of the hardware controller to control said queuing of said commands in response to task management and/or queue exceptions.

3. The method of claim 1, wherein setting in circuitry of the hardware controller, allowed queue depths comprises configuring allowed queue depth bit flags in said circuitry using firmware.

4. The method of claim 3, further comprising:
for each one of said plurality of target devices, using firmware to dynamically adjust the allowed queue depth setting in said circuitry in accordance with a status report received from the target device.

5. The method of claim 1, wherein setting in circuitry of the hardware controller, allowed queue depths comprises:
setting in said circuitry respective queue depths for first and second target devices, said queue depth for said first device being limited with respect to the queue depth of said second device; and
using said circuitry to control queuing of said commands to said first target depth according to the limited queue depth setting of said first target device such that commands to said first target device are throttled.

6. The method of claim 1, wherein setting in circuitry of the hardware controller, allowed queue depths comprises setting respective allowed queue depths for first and second target devices of said plurality of target devices, said allowed queue depth setting of said first target device being higher/lower than said second target device such that commands to said first target have a higher/lower priority than commands to said second target device.

7. The method of claim 1, further comprising using circuitry of said hardware controller to automatically start queued commands after completion of a previous command.

8. A hardware controller for controlling commands for a plurality of target devices, the hardware controller comprising:
queue depth settable circuitry adapted to enable queue depths of each one of a plurality of target devices supported by the controller to be set in said circuitry;
status monitoring circuitry adapted to monitor the status of each one of said plurality of target devices; and
queue management circuitry adapted to control queuing of said commands for each one of said plurality of target devices according to the queue depth setting for the target device.

9. The controller of claim 8, further comprising:
circuitry adapted to control said queuing of said commands in response to task management and/or queue exceptions.

10. The controller of claim 8, wherein said queue depth setting circuitry comprises bit flags adapted to be configurable using firmware.

11. The controller of claim 10, wherein said queue depth setting circuitry is adapted to enable dynamic adjustment of said queue depth settings using firmware.

12. The controller of claim 8, further comprising circuitry adapted to automatically start queued commands after completion of a previous command.

13. A system for controlling commands for a plurality of target devices, the system comprising:
an initiator; and
a hardware controller operably coupled to said initiator;
wherein said hardware controller comprises:
a queue depth settable circuitry adapted to enable queue depths of each one of a plurality of target devices supported by the controller to be set in said circuitry;
status monitoring circuitry adapted to monitor the status of each one of said plurality of target devices; and
queue management circuitry adapted to control queuing of said commands for each one of said plurality of target devices according to the queue depth setting for the target device.

14. The system of claim 13, wherein said hardware controller further comprises:
circuitry adapted to control said queuing of said commands in response to task management and/or queue exceptions.

15. The system of claim 14, wherein said queue depth setting circuitry is adapted to enable dynamic adjustment of said queue depth settings using firmware; and
further comprising firmware for dynamically adjusting said queue depth settings in accordance with a status report received from the target device.

16. The system of claim 13, wherein said hardware controller comprises circuitry adapted to automatically start queued commands after completion of a previous command.

17. The system of claim 13, where said initiator device comprises a SAS/SATA initiator device.

18. The system of claim 13, wherein said plurality of target devices comprise SAS and/or SATA target devices.

19. The system of claim 13, wherein said hardware controller comprises an ASIC

20. The system of claim 13, wherein said circuitry comprises one or more state machines.
